(19) United States
(12) Patent Application Publication
(10) Pub. No.: US 2007/0100979 A1
(43) Pub. Date: May 3, 2007

(54) Virtualized utility service platform

(75) Inventors: Shannon J. Soland, Saint Louis, MO (US); Andrew K. Matthys-Pearce, Saint Louis, MO (US); Richard M. Mutrux, Wildwood, MO (US)

Correspondence Address: DAVIDSON BERQUIST JACKSON & GOWDEY LLP, 4300 WILSON BLVD., 7TH FLOOR, ARLINGTON, VA, 22203, US

(73) Assignee: SAVVIS Communications Corporation, Town & Country, MO (US)

(21) Appl. No.: 11/294,489

(22) Filed: Dec. 6, 2005

Related U.S. Application Data
(60) Provisional application No. 60/731,937, filed on Nov. 1, 2005.

(51) Int. Cl. G06F 15/173

(52) U.S. Cl. 709/223

(57) ABSTRACT

A virtualized utility service platform includes a network infrastructure on which a plurality of virtual networks can be provisioned; a hosting infrastructure on which a plurality of virtual hosting systems can be provisioned; a computing infrastructure on which a plurality of virtual computing systems can be provisioned; and a storage infrastructure on which a plurality of virtual storage systems can be provisioned. A system provisioning mechanism provides one or more of: a virtual system comprising a virtual network, virtual hosting, virtual computing and a virtual storage system. The system provisioning system causes the virtual network to be provisioned on the network infrastructure; the virtual hosting to be provisioned on said hosting infrastructure; the computing infrastructure to be provisioned on said computing infrastructure and the virtual storage system to be provisioned on said storage infrastructure.

### CROSS-REFERENCE TO RELATED APPLICATIONS

This application claims the benefit of U.S. Provisional Application Serial No. 60/731,937 filed Nov. 1, 2005, the entire contents of which are herein incorporated by reference.

### FIELD OF THE INVENTION

This invention relates to data processing. More particularly, this invention relates to virtualized utility service platforms and related methods, systems and devices for provisioning such systems.

### BRIEF DESCRIPTION OF THE DRAWINGS

The invention is better understood by reading the following detailed description with reference to the accompanying drawing in which:

FIGS. 1-3 depict an exemplary virtualized utility service platform according to embodiments of the present invention.

### DESCRIPTION OF PRESENTLY PREFERRED EXEMPLARY EMBODIMENTS

Background and Overview

Companies are changing their computer/information technology (IT) infrastructures from ones in which they host and support all of their IT-related requirements, to infrastructures in which some or all of their computer needs are effectively outsourced. Today it is possible for an entity to obtain remotely supported and operated computer facilities for most of computer uses and IT requirements. Computers (servers, processors, etc.), computer storage of all types, security features, network access and software can all be accessed remotely, effectively creating a virtual IT department.

As used herein, the term “virtual” with reference to a component means that the user is provided with the functionality of that component, but may not, in fact, be provided with the component itself. For example, a user may have a virtual processor of a certain type. As used herein, this means that the user is provided with access to a processor with the capabilities of the correct type, but those capabilities may, in reality, be obtained in some other manner (e.g., by a different processor).

Existing IT systems have a number of problems. First, in existing virtual systems, each aspect of the system (memory, processor power/capabilities, software, network capabilities, etc.) is separately purchased, configured, supported and managed. This means that a user wanting a certain architectural configuration has to essentially configure each component of that configuration, with the burden being on the user to ascertain the appropriate architecture and components and the burden being on the user to ensure compatibility of the components and feasibility of the architecture. In addition to being time consuming, such systems are inherently error prone. Users are able to set up system configurations that do not work or do not meet their needs. Furthermore, such configurations are often not easily modified.

Traditional systems are implemented as follows:

A customer purchases various desired features and options. Typically these features and options are specified in terms of particular products and systems. For example, the customer may want the functionality of fifty desktop computers. In legacy virtual systems, the customer would try to replicate the actual architecture in the virtual architecture. The customer's order is entered, after which the system has to be appropriately provisioned and then validated. If the system cannot be validated (because, e.g., the customer chose invalid or improper combinations of options and features), then the order has to be modified, re-provisioned and re-validated. The traditional cycle of customer purchase, order entry, system provisioning and system validation takes anywhere from thirty to sixty days. In addition to the time uncertainty (how long provisioning will take), there are associated cost uncertainties. Essentially, a customer cannot tell how much a system is going to cost until the system is validated. Until then, the system may change and have to be re-priced.

The inventors were the first to realize that, given the complexity of IT architectures, it would be highly desirable to automate the entire provisioning process, and that it would be greatly advantageous to be able to reduce the provisioning time, while at the same time providing accurate costing, documentation and system validation. Accordingly, in some aspects, the present invention provides a virtual provisioning system that is capable of going from customer order to system validation much quicker than the legacy thirty to sixty days—preferably in thirty to sixty minutes.

The configuration system according to embodiments of the present invention treats the various components of a system as an integral virtual system.

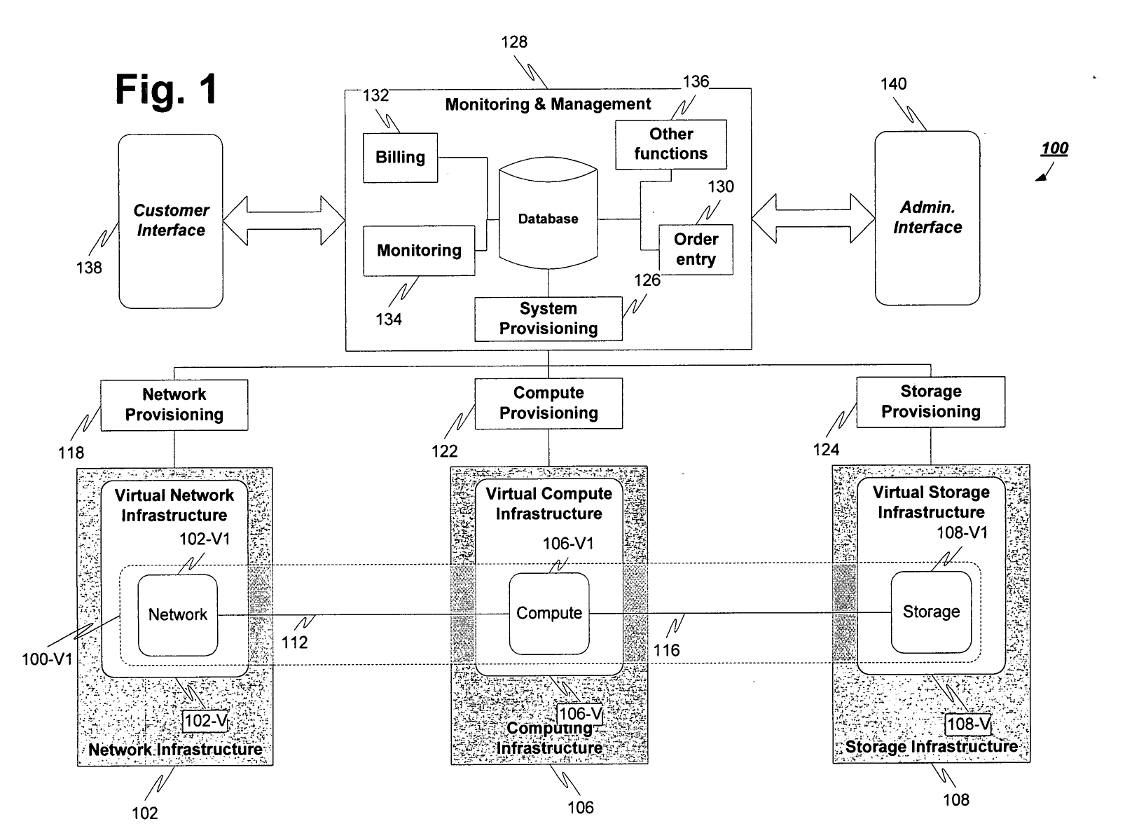

A virtual platform (Virtualized Utility Service Platform) is provided by provisioning a number of virtual components on an underlying physical system. Thus, with reference to FIG. 1, a system (generally denoted 100) includes a network infrastructure 102, a computing infrastructure 106, and a storage infrastructure 108. These various physical infrastructures are appropriately interconnected, as well understood by those of skill in the art.

Each of the various infrastructure components is configurable so as to allow virtual components to be formed thereon, and virtual infrastructures are implemented on the physical infrastructure. A virtual network infrastructure 102-V is implemented on the network infrastructure 102; a virtual computing infrastructure 106-V is implemented on the computing infrastructure 106; and a virtual storage infrastructure 108-V is implemented on the storage infrastructure 108.

Within each of the virtual infrastructures, logically separate components can be configured. For example, the network infrastructure 102 supports a virtual network infrastructure 102-V, within which a particular virtual network 102-V1 can be provisioned. Similarly, the computing infrastructure 106 supports a virtual compute infrastructure 106-V within which a particular virtual compute system 106-V1 can be provisioned; and the storage infrastructure 108 supports a virtual storage infrastructure 108-V, within which a particular virtual storage system 108-V1 can be provisioned.

In this manner, a virtual IT system (made up of various virtual components) can be provisioned. In the example shown in FIG. 1, a virtual IT system 110-V1 (shown enclosed by a dashed line) is made up of virtual network 102-V1, virtual compute 106-V1 and virtual storage 108-V1, along with appropriate virtual inter-connections (112, 114).

While FIG. 1 shows only one virtual component (network 102-V1, compute 106-V1 and storage 108-V1) within each virtual infrastructure, those skilled in the art will, of course, realize that each virtual infrastructure supports multiple such components. In addition, those skilled in the art will realize that certain distinct virtual components may share physical infrastructure. A particular combination of provisioned components (e.g., network 102-V1, compute 106-V1 and storage 108-V1) form a virtual system (which may be denoted 100-V1).

Each of the various components may be individually provisioned in an appropriate manner. The manufacturer of each system typically provides an interface to enable provisioning of their system. Thus, as shown in FIG. 1, the virtual network infrastructure 102-V (implemented on the network infrastructure 102) may be provisioned by a network provisioning mechanism 118; the virtual compute infrastructure 106-V (implemented on the compute infrastructure 106) may be provisioned by a compute provisioning mechanism 122; and the virtual storage infrastructure 108-V (implemented on the storage infrastructure 108) may be may be provisioned by a storage provisioning mechanism 124.

As used herein, the term “mechanism” generally refers to hardware, software and/or combinations thereof. A mechanism may be implemented on any type of computer using any programming language or system. A mechanism may provide an API (Application Programming Interface).

The system 100 includes a system provisioning mechanism 126 which interfaces, inter alia, with the various component provisioning mechanisms, i.e., with network provisioning mechanism 118, hosting provisioning mechanism 120, compute provisioning mechanism 122, and storage provisioning mechanism 124.

The system provisioning mechanism 126 is part of a system monitoring and management component 128 which is used to obtain and fulfill customer orders (130), document provisioning artifacts, administer the system, perform billing (132), monitor the system (134) and perform various other functions (136). The various physical and virtual components are preferably operated by a service provider, and users of the system are generally referred to herein as customers of the service provider. The service provider may own and operate some or all of the physical infrastructure. Infrastructure built to support virtual services is usually built with extensive internal redundancy and resource partitioning functionality. These features are often more expensive than the devices sold to enterprises as point solutions. It is more affordable for a service provider to acquire these devices, integrate them with management systems, and spread the cost across multiple customers than the alternative of an end user buying and deploying the same devices.

In typical operation of preferred embodiments of the present invention, a customer is provided with a customer interface 138 which interfaces to appropriate parts of the monitoring and management component 128 and which can be used, among other things, to order or configure a virtual system. The service provider has an administrative interface 140 which allows administrative access to the various components of the monitoring and management component 128. The customer interface 138 and the administrative interface 140 are preferably graphical user interfaces (GUIs) and both are preferably accessible via the Internet. Those skilled in the art will realize that appropriate security procedures are used to control and limit access to the monitoring and management component 128.

In a typical operation of the system 100, a user/customer accesses the order entry system 130 of the monitoring and management component 128 via the customer interface 138 and orders a virtual system. As used herein, a user may be, e.g., a sales representative. The user may order a system by specifying requirements for computation requirements, storage requirements, and network requirements. The computation requirements may include some or all of: number and type of processors, software applications to be run, security requirements, performance requirements, and expected qualities of service (e.g., High Availability Failover Pool) The memory requirements may include amounts of memory of different types, security requirements, and performance requirements. The network requirements may include security requirements, performance requirements, throughput requirements, and connectivity requirements.

The above lists are merely exemplary, and those skilled in the art will realize that other and/or different options may be listed.

The customer may be presented with various billing plans or options, with pricing based, at least in part, on various requirements selected. Those skilled in the art will realize that different billing options and plans may be provided for different customers and for different types of customers.

In some preferred embodiments of the invention, the order entry system 130 will only allow the customer to select compatible components. In this manner, the customer can be assured that the ordered system can be provisioned. In some embodiments of the present invention, the order entry system 130 may present the customer with selections of different exemplary systems that might meet the customer's requirements. The customer may then select and customize one of these exemplary systems.

Customer-selected configurations may be provisioned by the provisioning system 126. In some embodiments of the present invention, the service provider reviews orders before they are provisioned.

When an order is filled and a virtual system is provisioned, the customer is given access to the virtual system. In preferred embodiments, each virtual system is monitored (by monitor mechanism 134) in order to check that the virtual system is operating correctly and satisfying the customer's requirements. In some embodiments of the present invention, a customer may elect to have a system re-provisioned when monitoring reveals that the virtual system is not able to meet the customer's requirements. In this manner, customers are able to order minimal virtual systems and to automatically add capacity when needed (or remove capacity when not needed). This allows customers to only pay for what they use or for what is actually provisioned. Either (or both) of the billing/payment models—capacity provisioned vs. capacity used—may be used.

Network: In presently preferred implementations of the invention, the network infrastructure 102 uses one or more high-performance security switches (such as the Savvis Virtual Services Switch—VSS). As part of the invention's virtualized services delivery platform, in some implementations, the Virtual Service Switch centralizes network, security, and performance services onto a single platform. Multiple security functions including firewall, VPN, SSL acceleration, and load balancing are consolidated and virtualized using a Virtual Service Switch.

One presently preferred implementation, uses the Virtual Services Switch to provide application services such as firewall, load balancing, and ssl termination. The VSS platform is composed of two main components. The first component is the centralized management system called CenterPoint which is used for monitoring, configuring, provisioning, and managing the VSS hardware. CenterPoint is used to create, configure, and deploy client configurations. The VSS hardware is the second component. The VSS hardware includes input/output interface cards, service processing modules (SPM), and switch management modules. The hardware is where the client traffic resides and is subsequently subject to one or more of the aforementioned virtual service module services.

Computing: The computing infrastructure 106 is preferably made up of a number of processors such as, e.g., Egenera BladeFrame™ computers, sold by Egenera, Inc., of Massachusetts.

In the presently preferred embodiment, the computing infrastructure 106 is made up of a collection of server processors in a rack. In current versions, each system includes processing blades, redundant control blades, redundant switch blades and a redundant backplane. The control blade hosts manager software which manages the computing infrastructure. Two control blades provide external I/O connectivity for the processing blades and run the management software. Control blades have connections to external devices.

In some preferred embodiments, processors in the computing infrastructure 106 are connected by high-speed, switched-fabric interconnects which provide switching for internal (blade-to-blade, TCP/IP traffic) and external traffic. In some embodiments, these switched-fabric interconnects automatically load balance traffic.

In some presently preferred implementations, the architecture of the computing infrastructure system virtualizes data center infrastructure by creating a pool of server resources from which private, secured configurations can be dynamically allocated to support an application and then disbanded if necessary. With this approach, server capacity no longer must be dedicated to individual applications, and services are not tied to specific hardware or network paths. As a result, clients need pay only for the resources they use and have access to powerful features such as high availability, disaster recovery and real-time scalability without over-provisioning.

Storage: Preferred storage infrastructure systems support different external storage subsystems, including NAS (Network-attached storage), SAN (Storage Area Network), and Small Computer System Interface (SCSI) external storage subsystems. In a presently preferred exemplary implementation, the storage infrastructure 108 is made up of 3Par Inserv S400 storage servers, sold by 3PARdata, Inc. of Fremont, Calif. The storage infrastructure 108 is a scalable and controllable information infrastructure.

Those of skill in the art will realize that other appropriate systems may be used for the various infrastructure components. In addition, those of skill in the art will realize that other aspects of a virtual system, e.g., security and software requirements, may be separately provisioned, and that a virtual system according to embodiments of the present invention is not limited to the four components shown.

The virtualized utility services of the present invention provide many advantages over legacy systems. The virtualized utility services delivery platform according to embodiments of the present invention is based on advanced, automated software management and provisioning systems that provide customers with a simple, yet comprehensive end-to-end view of their IT infrastructure. This visibility across network, hosting, compute and storage platforms creates efficiencies, enabling the service provider to be much more responsive to customers' needs and to reduce customer dependence on redundant hardware.

Unlike the traditional service provider model, in which companies must pay for excess and unused capacity, the virtualized delivery platform according to embodiments of the present invention routinely and automatically optimizes resource allocation for each client. This allows customers to pay for only what they use. Additionally, it lessens the burden of capital expenditures and legacy systems. As a result, the platform increases a company's flexibility and agility, making it possible to add new applications, increase server and storage, and expand the network in less time than conventional alternatives.

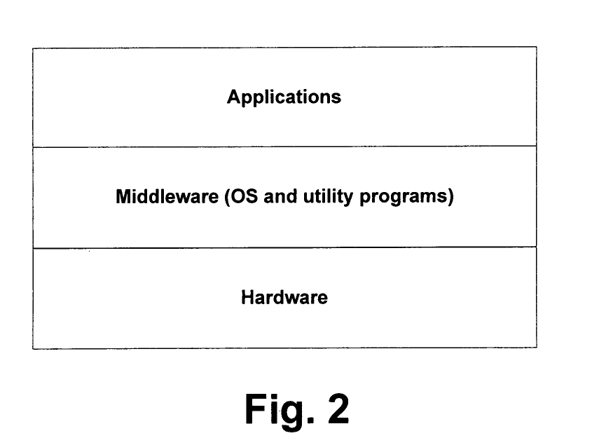

Thus far the invention has been described with reference to the provisioning of the hardware components of a system. A IT system may be viewed in an hierarchical manner, e.g., as shown in FIG. 2, comprising hardware, so-called middleware (consisting, e.g., of operating system and utility software), and applications. The description so far has essentially described the provisioning of the lowest level of this hierarchy.

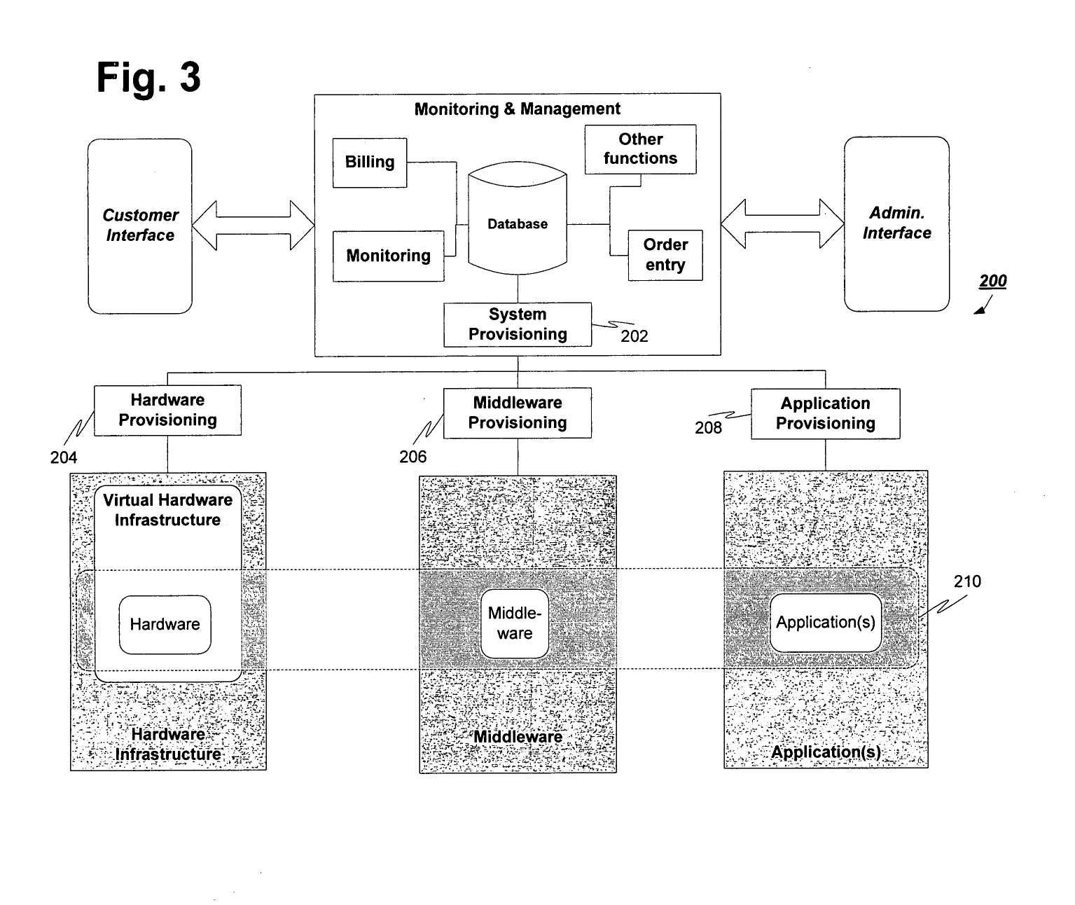

In some embodiments of the present invention, mechanisms are also provided to enable virtual provisioning of the middleware and applications levels of the system. FIG. 3 depicts an exemplary virtualized utility service platform 200 according to some embodiments of the present invention. The service platform 200 includes a system provisioning mechanism 202 that controls hardware provisioning mechanism 204, middleware provisioning mechanism 206, and application provisioning mechanism 208. Each of these three mechanisms corresponds to one of the levels in the hierarchy shown in FIG. 2. Those skilled in the art will immediately realize that the hierarchy may be defined differently and may include different levels and/or categories. The various provisioning mechanisms may be provided for each level and/or category. In addition, those skilled in the art will realize that some of the boundaries of the hierarchy may be imprecise, and thus the corresponding mechanisms may overlap in functionality and ability. For example, if it is unclear whether a certain computer program is middleware or an application, the system may allow both the middleware provisioning mechanism 206 and the application provisioning mechanism 208 to provision that program.

The hardware provisioning mechanism 204 essentially corresponds to the system provisioning 126 described above with reference to FIG. 1. It is used to provision the hardware components (network, computing and storage). The middleware provisioning mechanism 206 provisions various lower and middle level software such as operating systems, utilities, and the like. The application provisioning mechanism 208 provisions applications such as hosting, accounting, and the like.

By providing an hierarchical provisioning system, a user is able to provision an entire system by specifying his requirements at any of the levels in the hierarchy, in some cases without specifying the requirements for lower levels. For instance, a particular user may require accounting functionality for a certain number of users. That user can invoke the system provisioning mechanism 202, specify the requirements at the application level and have the entire system (hardware, middleware and application) provisioned. Another user may wish to provision a system at the middleware level, e.g., to use or support a particular operating system. That user can invoke the system provisioning mechanism 202, specify the requirements at the middleware level, and have the entire system (hardware and middleware) provisioned.

An exemplary provisioned system is shown by the dashed line (denoted 202 in FIG. 3), which includes a virtual hardware component, a middleware component and an application component.

In order to support this hierarchical and intelligent provisioning, the system maintains a list or database of hardware requirements for each type of middleware and of hardware and middleware requirements for each application.

As described above with reference to the hardware provisioning, the system monitors the virtual system and can modify the resource allocation as needed.

### EXAMPLE

Aspects of an exemplary implementation of are now described, along with an exemplary work flow and ordering system. Those skilled in the art will realize that other work flows and other implementations are possible and are within the scope of the invention.

Some or all of the following are options provided by GUI to users in an exemplary implementation of the invention. The user is able to select the desired option using an appropriate selection mechanism (e.g., mouse, keyboard or other device).

Database Software:
Database Server Software Options:
   Application:
      MySQL
      Microsoft SQL
      Oracle
   CPU License Count:
      1 CPU License
      2 CPU License
      2 CPU License/Limited Use
      4 CPU License
      4 CPU License/Limited Use
      8 CPU License
   Database Version
      2000
      9i
      10G
   Database Type
      N/A
      Standard
      Enterprise
      RAC
      Partitioning

Server Application:
Server Application Options:
   Application:
      BEA Weblogic
      Coldfusion
      Microsoft Application Center
      Microsoft Biztalk
      Microsoft Commerce Server
   Application Type
      N/A
      Standard
      Advantage
      Premium
      Enterprise
      Professional
   CPU License Count
      N/A
      1 CPU License
      2 CPU License
      4 CPU License

Web Application Software
Web Application Software Options:
   Application:
      Microsoft IIS Web Application
      Apache Web Application
      SunOne Web Server
   CPU License Count
      N/A
      1 CPU License
      2 CPU License
      4 CPU License

Remote Access Applications
Remote Access Application Options:
   Application:
      PC Anywhere
      Citrix Metaframe XP
      Microsoft Terminal Services
   User License Count
      N/A
      10 User License Pack
      20 User License Pack
      50 User License Pack

Storage Software Applications
Remote Access Application Options:
   Application:
      Veritas Storage Foundation for Oracle
      Veritas Storage Foundation for Oracle RAC
   Configuration Type (This option should default to read-only/null without any value when Oracle RAC is selected)
      Standard
      High Availability (HA)
   Tier (Veritas has Tiers for all Solaris OS based servers. This option will contain selectable values when the parent server is a Sun server with a Solaris OS)
      1a
      1b
      1c
   CPU Count (Tier & CPU Count are shared options. Only one of these options is detailed based on the operating system of the server. Tier is for Solaris based Severs. CPU Count is for Linux based servers.)
      2 CPU
      4 CPU

Utility Storage
Utility Storage Options
   QOS
      1
      2
      2
   Storage Amount
      Drop down list displaying all available storage amounts up to 2 TB of data. This is set in 50 GB increments up to 1 TB.
   Storage Copy Type
      N/A
      Remote Copy
      Snap Copy
      Virtual Copy
   Storage Copy Amount
      Drop down list displaying all available storage amounts based on the parent Storage Amount Option. The storage copy amount limited to be equal or lesser to the Storage Amount option value.

In some presently preferred implementations, the following other features may be purchased by customers. utility security firewall; managed utility SSL acceleration; customer access; and managed utility load balancing service.

In a presently preferred implementation, utility storage is sold in fifty Giga Byte increments. Other increments are considered to be within the scope of the invention.

In some cases, the selection of certain options may preclude (or enable) other options. For example, selection of a certain type of processor may preclude (or require) certain types of memory. In these cases, the GUI enables or disables certain options, as appropriate. E.g., for storage software applications, High Availability (HA) is the only option available when the Operating System of the parent Managed Server or Virtual Server is any version of Linux.

Pricing

Any type of pricing scheme may be used. In some cases, components are priced per unit, in others for use. Combinations of these schemes may be used. E.g., processors may be priced based on a CPU count. Bandwidth may be priced, e.g., based on Mbps Burstable Bandwidth, i.e., is the minimum/base burstable bandwidth tier the customer has purchased. This will be the customer's minimum charge for bandwidth per month. For hosting, preferably per megabyte pricing is used. The pricing is preferably set up to capture revenue as higher meg usage is generated.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A virtualized utility service platform comprising:
a network infrastructure on which a plurality of virtual networks can be provisioned;
a computing infrastructure on which a plurality of virtual computing systems can be provisioned;
a storage infrastructure on which a plurality of virtual storage systems can be provisioned; and
a system provisioning mechanism constructed and adapted to provide one or more of: a virtual system comprising a virtual network, virtual hosting, virtual computing and a virtual storage system, said system provisioning system causing said virtual network to be provisioned on the network infrastructure; said virtual hosting to be provisioned on said hosting infrastructure; said computing infrastructure to be provisioned on said computing infrastructure and said virtual storage system to be provisioned on said storage infrastructure.

2. A platform as in claim 1 further comprising:
a network provisioning mechanism constructed and adapted to provision a virtual network on said network infrastructure, and wherein said system provisioning mechanism is constructed and adapted to cause said network provisioning mechanism to provision a virtual network.

3. A platform as in claim 1 further comprising:
a hosting provisioning mechanism constructed and adapted to provision a virtual hosting system on said hosting infrastructure, wherein said system provisioning mechanism is constructed and adapted to cause said hosting provisioning mechanism to provision virtual hosting systems.

4. A platform as in claim 1 further comprising:
a storage provisioning mechanism constructed and adapted to provision a virtual storage system on said storage infrastructure, wherein said system provisioning mechanism is constructed and adapted to cause said storage provisioning mechanism to provision virtual storage systems.

5. A platform as in claim 1 further comprising:
a computing provisioning mechanism constructed and adapted to provision a virtual computing system on said computing infrastructure, wherein said system provisioning mechanism is constructed and adapted to cause said computing provisioning mechanism to provision virtual computing systems.

6. A platform as in claim 1 further comprising:
a network provisioning mechanism constructed and adapted to provision a virtual network on said network infrastructure, and wherein said system provisioning mechanism is constructed and adapted to cause said network provisioning mechanism to provision a virtual network;
a storage provisioning mechanism constructed and adapted to provision a virtual storage system on said storage infrastructure, wherein said system provisioning mechanism is constructed and adapted to cause said storage provisioning mechanism to provision virtual storage systems; and
a computing provisioning mechanism constructed and adapted to provision a virtual computing system on said computing infrastructure, wherein said system provisioning mechanism is constructed and adapted to cause said computing provisioning mechanism to provision virtual computing systems.

7. A platform as in claim 1 further comprising:
a customer interface constructed and adapted to accept customer orders specifying aspects of a required virtual system, wherein the system provisioning mechanism is constructed and adapted to provision said required virtual system.

8. A platform as in claim 1 further comprising:
a monitoring mechanism constructed and adapted to monitor a virtual system and to cause the virtual system to be re-provisioned based, at least in part, on said monitoring.

9. A platform as in claim 8, wherein said re-provisioning takes place when said monitoring mechanism determines that the virtual system requires additional capacity.

10. A platform as in claim 9 wherein said re-provisioning takes place if a customer has previously agreed thereto.

11. A virtualized utility service platform comprising:
a network infrastructure on which a plurality of virtual networks can be provisioned;
a computing infrastructure on which a plurality of virtual computing systems can be provisioned;
a storage infrastructure on which a plurality of virtual storage systems can be provisioned;
a hardware provisioning mechanism constructed and adapted to provide one or more of: a virtual system comprising a virtual network, virtual hosting, virtual computing and a virtual storage system; and
an application provisioning mechanism constructed and adapted to provide an application and to cause said hardware provisioning mechanism to provision a virtual network on the network infrastructure; and to provision a computing infrastructure on said computing infrastructure and to provision a virtual storage system on said storage infrastructure.
